(19) United States
(12) Patent Application Publication
(10) Pub. No.: US 2013/0191256 A1
(43) Pub. Date: Jul. 25, 2013

(54) AUTOMATED TAX DIAGNOSTIC SYSTEMS AND PROCESSES

(71) Applicant: LCR-Dixon Corporation, Bel Air, MD (US)

(72) Inventors: Jeffrey J. Bleacher, Bel Air, MD (US); Susan M. Soo, Carmel Valley, CA (US)

(73) Assignee: LCR-Dixon Corporation, Bel Air, MD (US)

(21) Appl. No.: 13/747,055

(22) Filed: Jan. 22, 2013

Related U.S. Application Data
(60) Provisional application No. 61/588,832, filed on Jan. 20, 2012.

(51) Int. Cl. G06Q 40/00

(52) U.S. Cl. CPC G06Q 40/103
USPC 705/31

(57) ABSTRACT

Accounting functionality integratable into an ERP system such as, e.g., SAP® is described. The functionality provides multiple features including automatically reconciling vendor-billed tax such as on manual or automatic invoices and tax calculated by third party tax software. The functionality is configurable to automatically decide if a particular document is to be processed based on various parameters. Appropriate outputs may be made to accounting records. In one aspect, the functionality includes calculating and recording tax accruals on various sources including inventory movements. In one aspect, automation of the process of evaluating the accuracy of transaction tax results on procure-to-pay and order-to-cash transaction data is described.

### CROSS-REFERENCE TO RELATED APPLICATIONS

This application claims benefit and priority to U.S. Provisional Application No. 61/588,832 filed Jan. 20, 2012, the disclosure is incorporated by reference herein in its entirety.

### BACKGROUND

1.0 Field of the Invention

The invention is directed to a system and method for providing enhanced accounting functionality to be used with corporate enterprise resource planning (ERP) systems and, more particularly, to a system, computer program product, and method for providing enhanced accounting functionality to be used with corporate enterprise resource planning (ERP) systems to monitor, identify and reconcile tax computations on transactions, and the like.

2.0 Related Art

ERP systems today are not tailored to provide for monitoring and validating tax computations that may be received from, e.g., vendors. Tax calculations may vary based on various factors such as geographic location of where a tax calculation is being performed perhaps by a vendor in one state when the tax should be calculated differently based on another state, for example. An invoice may be received that may include a tax that is miscalculated, or no tax applied at all. In any event, the accuracy of the tax calculation is incorrect and may lead to inaccurate financial reporting, under or overpayment of invoices and/or taxes.

An automated/real time solution to improve the accuracy of tax calculations related to ERP systems would be a significant advancement of the current available art.

### SUMMARY OF THE DISCLOSURE

The invention, as described herein discloses AUTOMATED TAX DIAGNOSTIC SYSTEMS AND PROCESSES and other advantages apparent from the discussion herein.

In one aspect, a system for reconciling a tax amount calculated by different sources, the system including an enterprise resource platform (ERP) having a processor operable to execute ERP software and configured to generate one or more remote function calls to tax software; the tax software independently installable and operable to execute on the ERP platform and configured to execute the one or more function calls including configured to execute logic to determine accuracy of a tax item related to an invoice or a purchase order; and an output device to receive an output from the tax software indicative of the accuracy of the tax item. The tax software may be configurable to determine an output based on variables such as tax codes, invoice thresholds, vendors, states, overpayment vs. underpayment and taxability. The tax software may be configurable to determine whether one of: a purchase order based invoice and a non-purchase order based invoice has an inaccurate tax amount and provides an output indicative of a correct tax amount or indicative of no change. The tax software may be configurable to operate at a line or invoice level, and may be configurable to process manually input invoices and automatic invoices.

In one aspect, a computer program product embodied on a computer readable medium and comprising executable code for reconciling of a tax amount that when read and executed by a computer causes the execution of the following steps: processing at a tax software module a remote function call called from an ERP platform to execute logic to determine accuracy of a tax item related to an invoice or a purchase order and outputting an indication of the accuracy of the tax item. The tax software module may determine an output based on a variable including a variable indicating at least one of a tax code, an invoice threshold, a vendor, a state, an overpayment vs. underpayment and taxability. The tax software module may determine whether one of: an invoice purchase order based invoice and a non-purchase order based invoice has an inaccurate tax amount and provides an output indicative of a correct tax amount or indicative of no change. The tax software module may operate at a line or invoice level and may process manually input invoices and automatic invoices. The tax software module may analyze gaps in reporting data for internal audits or external audits and identifies gaps in reported tax amounts and reports gaps in tax amounts for transactions. A table configuration may defines documents for analysis by the tax software module, the analysis being controlled by a variable including a variable indicating at least one of: a tax code, a vendor, a General Ledger account, a material group, a cost object, and an expected taxability by state.

In one aspect, a computer-implemented method for reconciling of a tax amount, the method including the steps of processing tax software by a computer processor including a remote function call called from an enterprise resource planning (ERP) platform to execute logic to determine accuracy of a tax item related to an invoice or a purchase order and outputting to a device an indication of the accuracy of the tax item. The indication may be determined based on a variable indicating at least one of: a tax code, invoice thresholds, a vendor, a state, an overpayment vs. underpayment and taxability. The computer-implemented method may further comprise the step of determining whether one of: a purchase order based invoice or a non-purchase order based invoice has an inaccurate tax amount and providing an output indicative of a correct tax amount or indicative of no change. The tax software may operate at a line or invoice level, and processes manually input invoices and automatic invoices. The computer-implemented method may further comprise reconciling the invoice by indicating at least one of: pay a vendor as billed, accrue tax if not billed by the vendor, accrue partial tax not billed by the vendor and short-pay the vendor. The computer-implemented method may further comprise the step of analyzing for gaps in reporting data for internal or external audits of the invoices and identifies gaps in reported tax amounts. The computer-implemented method may further comprise the step of calculating and recording tax accruals on inventory movements by the tax software. The computer-implemented method may further comprise the step of integrating the tax software into the ERP platform so that the ERP platform accesses the tax software through remote function calls.

Additional features, advantages, and embodiments of the invention may be set forth or apparent from consideration of the following attached detailed description. Moreover, it is to be understood that both the foregoing summary of the invention and the following attached detailed description are exemplary and intended to provide further explanation without limiting the scope of the invention as claimed.

### BRIEF DESCRIPTION OF THE DRAWINGS

FIG. 1 is a block diagram of an Enterprise Resource Planning (ERP) system 100 that may include one or more additional components, configured according to principles of the disclosure;

FIG. 2 is a flow diagram of the process controlled and/or provided by the VR 200 module, the process performed according principles of the invention;

FIG. 3 is a flow diagram showing steps of FB60/Manual non-purchase order invoice processing, performed according to principles of the invention;

FIG. 4 is a flow diagram of a VR process for automated invoices, performed according to principles of the invention;

FIG. 5 is a flow diagram showing how VR 200 adjusts invoices, performed according to principles of the invention,

FIG. 6A is an illustration of a screenshot that a user may view during the processing of VR 200, configured according to principles of the invention;

FIG. 6B is an illustration of a screenshot that a user may view showing a result of the processing of VR 200 for the invoice of FIG. 6A, configured according to principles of the invention;

FIG. 7A is an illustration of a screenshot that a user may view during the processing of VR 200, configured according to principles of the invention.

FIG. 7B shows a screenshot showing the VR 20 result, configured according to principles of the invention;

FIGS. 8A to 8E show screenshots of a scenario where a vendor overcharges a tax amount, configured according to principles of the invention;

FIG. 9A shows an example of VR 200 configuration table, configured according to principles of the invention;

FIG. 9B shows a table that defines for what countries VENDORecon should be used, configured according to principles of the invention;

FIG. 10 is a flow diagram showing flexRFC 300, performed according to principles of the invention;

FIG. 11 shows a screenshot of a Create Tax Accruals, configured according to principles of the invention;

FIG. 12 shows an exemplary table showing a list of source financial documents requiring a tax accrual, according to principles of the invention;

FIG. 13 shows an exemplary screenshot of part of a screenshot showing a tax calculated in test mode, according to principles of the invention;

FIG. 14 shows a screenshot showing a FI document posted with a tax accrual expense, according to principles of the invention;

FIG. 15 shows a screenshot of a tax accrual report;

FIG. 16 is a flow diagram showing the decision points and outcome options for flexRFC processing, performed according to principles of the invention;

FIG. 17 shows an example of a FI accounting document automatically created by a flexRFC to expense tax accrual, configured according to principles of the invention; and

FIG. 18 shows an exemplary screenshot of the use tax accrual in a third party Tax Software reporting that may be exported for tax returns purposes, configured according to principles of the invention.

### DETAILED DESCRIPTION OF THE INVENTION

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The database may be distributed over one or more networks. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, and volatile media. Non-volatile media may include, for example, optical or magnetic disks and other persistent memory. Volatile media may include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The various aspects of the invention as set forth in the attachment includes a new approach to automated tax diagnostics including an automated/real time solution to improve the accuracy of tax calculations related to ERP systems and third party tax software programs. The disclosure may refer to specific third party software programs such as, e.g., Vertex, however it should be understood that other third party software programs may be used and not limited to the specific third party tax software.

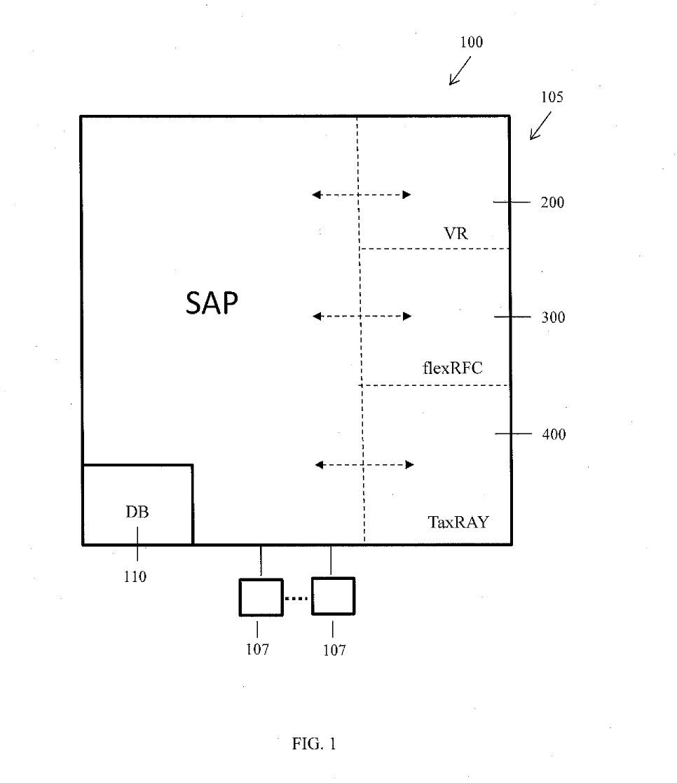

FIG. 1 is a block diagram of an Enterprise Resource Planning (ERP) system 100 that may include one or more additional components, configured according to principles of the disclosure. The ERP system 100 may comprise, e.g., a SAP® platform that permits integration of one or more third-party supplied modules 200, 300, 400 for expanding functional capability of the ERP system 100 inclusive of a third party tax processing software. The ERP system 100 comprises one or more computer platforms 105 that run the various traditional applications of an ERP system 100. The one or more computer platforms 105 may also incorporate the execution of the modules 200, 300 and 400, described more below. The system may also include one or more user interface devices 107, such as terminals or computers, for interaction (input and/or output) with the ERP applications and modules 200, 300 and 400. The system 100 may include a database 110 for storing enterprise records including, e.g., accounting records, material management records, financial records, tax records, inventory records, and the like. The database 110 may serve as an input and output device. The components of the ERP system 100 may be distributed.

In one aspect of the invention, a system and method (referred to generally as VENDORecon) for reconciling tax amounts calculated by different sources, such as, e.g., a vendor and an accounting system. In particular, VENDORecon (or “VR”) may comprise module 200 that may include a suite of custom Advanced Business Application Programming (ABAP) code that may be invoked during SAP® MM (Purchase Order related) and FI invoice (non-Purchase Order related) pre-processing and creation to automate the reconciliation between vendor-billed tax and tax calculated by any third party tax software operable with ERP systems, such as, but not limited to, for example, Vertex™, OneSource™, Taxware™, Sales Tax Office™, and the like (hereinafter Tax Software). The VENDORecon module 200, may offer the following functionality:
Integration with the SAP® invoice processing screens and programs where VR is virtually invisible to accounts payable (A/P) users, but the results during invoice “simulation” or posting making A/P processing much more efficient;
Table configuration to define documents that should invoke or bypass VR;
Desired outcomes can be configured based on variables such as tax codes, invoice thresholds, vendors, states, overpayment vs. underpayment and taxability;
Outcomes can be controlled based on tolerances that are percentage-based or dollar-based;
Capable of handling manually input invoices or automated invoices, such as IDocs/electronic data interchange (EDI). (IDoc is a standard data structure for electronic data interchange (EDI) between application programs written for the SAP® software business system or between an SAP® software application and an external program.)
Ability to handle invoice-level or line-level reconciliations (depending on the manner in which vendor tax is input); and/or
Error messaging may be configurable according to requirements.

THE VENDORecon module 200 may be delivered in a series of SAP® transport files containing the VR data dictionary object and program(s). As part of a typical installation process, the VR 200 may be integrated with the ERP system 100, such as SAP® system user exits and/or Badis.

The VENDORecon module 200 may be configurable to determine an outcome (e.g., an output) based on variables such as tax codes, invoice thresholds, vendors, states, overpayment vs. underpayment and taxability.

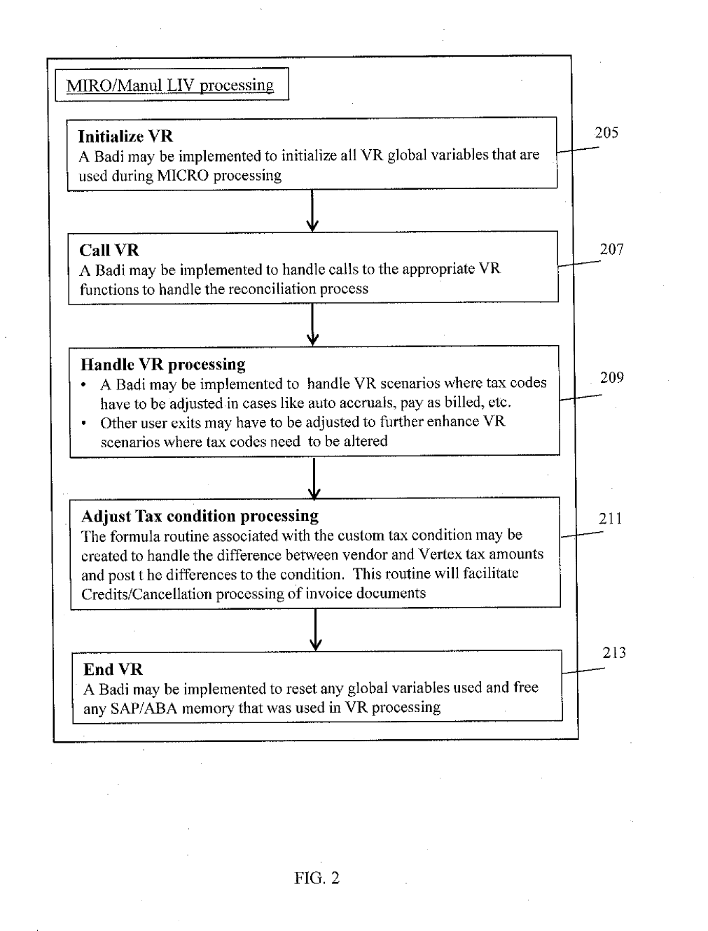

FIG. 2 is a flow diagram of the process controlled and/or provided by the VR 200 module, the process performed according principles of the invention. VR 200 includes function modules and may include classes/methods that are implemented within an ERP 100 environment (such as, e.g., SAP®) and may be called during, e.g., Materials Management (MM) or FI Invoice pre-processing, creation or change processes, and the like. FIG. 2 (and all other flow diagrams herein) may equally represent a high-level block diagram of components of the invention implementing the steps thereof. The steps of FIG. 2 (and all other flow diagrams herein)) may be implemented on computer program code in combination with the appropriate computing hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The program code may be embodied on a computer medium as a computer product, the code when read and executed performs the functions of the program code (such as the flow diagrams herein).

The process of FIG. 2 is for purchase order based invoicing. At step 205, a Badi may be implemented to initialize all VR variables that may be used during VR micro processing. At step 207, VR may be called to handle calls to appropriate VR functions to handle reconciliation process. At step 209, a Badi is implemented to handle VR scenarios where tax codes have to be adjusted in cases like accruals, pay as billed, and the like. Additional user exits are provided to handle tax codes that need to be altered. At step 211, adjusting of a tax condition may occur. The formula associated with the custom tax condition may be created to handle the difference between vendor and third party tax amounts (e.g., Vertex tax amounts). At step 213, a Badi is implemented to reset any global variables used to free any memory that was used during the VR processing.

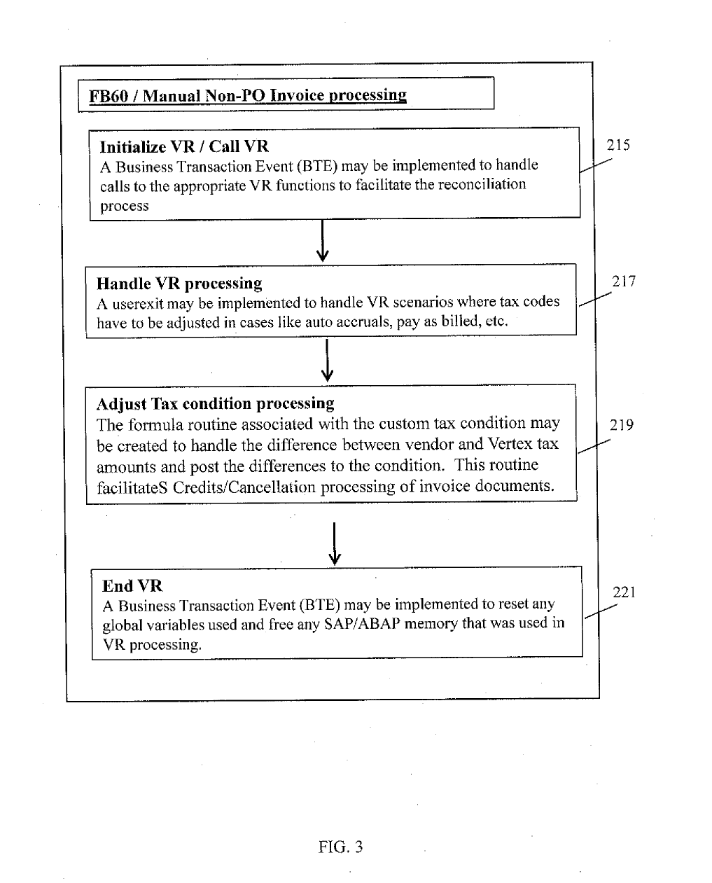

FIG. 3 is a flow diagram showing steps of FB60/Manual non-purchase order invoice processing, performed according to principles of the invention. At step 215, a business transaction event (BTE) is implemented to handle calls to appropriate VR functions to facilitate reconciliation. At step 217, a user exit is implemented to handle VR scenarios where tax codes have to be adjusted in cases like accruals pay as billed, and the like. At step 219, a tax condition may be adjusted. The formula associated with the custom tax condition is created and the difference handled between the vendor and third party tax (e.g., Vertex) amounts and the difference is posted to the condition. This facilitates credits/cancellation processing of invoice documents. At step 221, a business transaction event (BTE) is implemented to reset any global variables used and free any memory (e.g., SAP®/ABAP memory) that was used in the VR processing.

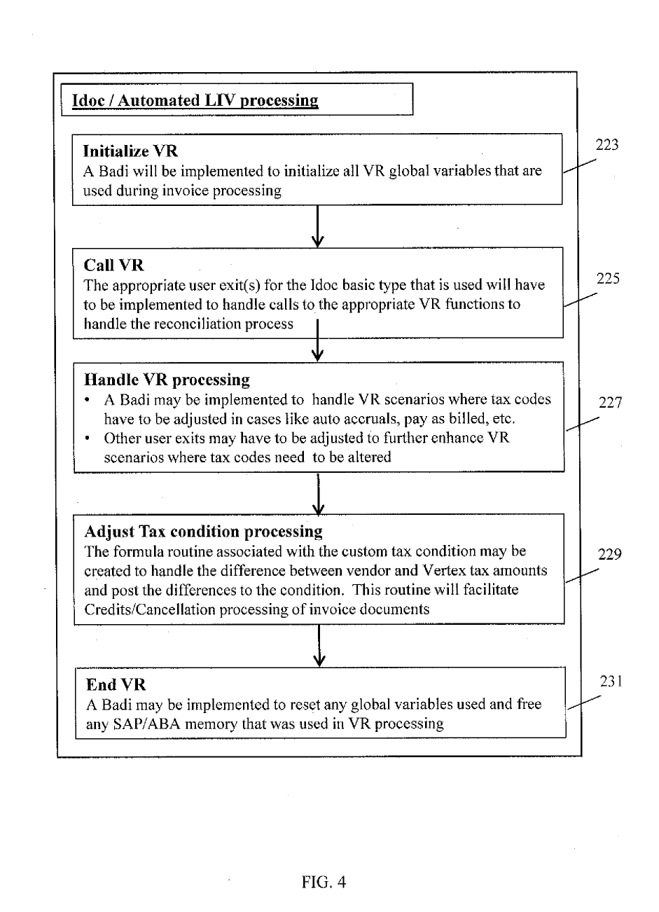

FIG. 4 is a flow diagram of a VR process for automated invoices, performed according to principles of the invention. At step 223, a Badi is implemented to initialize all VR global variables that are used during invoice processing. At step 225, the appropriate user exit for Idoc types is called to handle the VR reconciliation process. At step 227, a Badi is implemented to handle VR scenarios where tax codes have to be adjusted like auto accruals, pay as billed and the like. Other user exits may be implemented where tax codes need to be altered. At step 229, a tax condition may be adjusted. The formula associated with the custom tax condition is created and the difference handled between the vendor and third party tax (e.g., Vertex) amounts and the difference is posted to the condition. This facilitates credits/cancellation processing of invoice documents. At step 231, a Badi is implemented to reset any global variables used and to free any memory (e.g., SAP®/ABAP memory).

The VR 200 module automatically performs several functions during SP A/P invoicing, including the following steps:
Bifurcates processing for manual versus automated processing. Manual invoices may be created by direct user input via invoice screens such as MIRO (PO related) and FB60. Automated invoices are auto-generated from external systems or files (such as Idoc/EDI invoices).
Validates that the invoice should invoke the VR process. This may be based on the T-code, document type, country and/or tax procedure.
Determines if the VR process should handle at a line or invoice level. This distinction is that the line level VR processing reconciles each line item individually, whereas invoice (or header) level VR processing reconciles the invoice as a whole. A deciding factor is whether the vendor-billed taxes are entered into SAP® (or other ERP) on a line level or header level basis.
Compares tax software calculation tax to vendor-billed tax. This affects the type of adjustment needed.
Determines the outcome based on settings within the tax tolerance table by either:
   Automatically reconciling and balancing the taxes by one of the flowing:
      Paying the vendor as billed
      Accruing all tax if not billed by the vendor
      Accruing partial tax not billed by the vendor
      Short-paying the vendor
      Displaying an error or warning message for the user, or
      Leaving the invoice out of balance for manual adjustment
Depending on the outcome, handling the accounting entries—to adjust the third party tax (e.g., Vertex or vendor tax) and post to the proper general ledger (GL) accounts and tax conditions.
Depending on the outcome, showing a message—for the user, or a printed/stored message in the Text field of the invoice for printing on a check remittance stub.

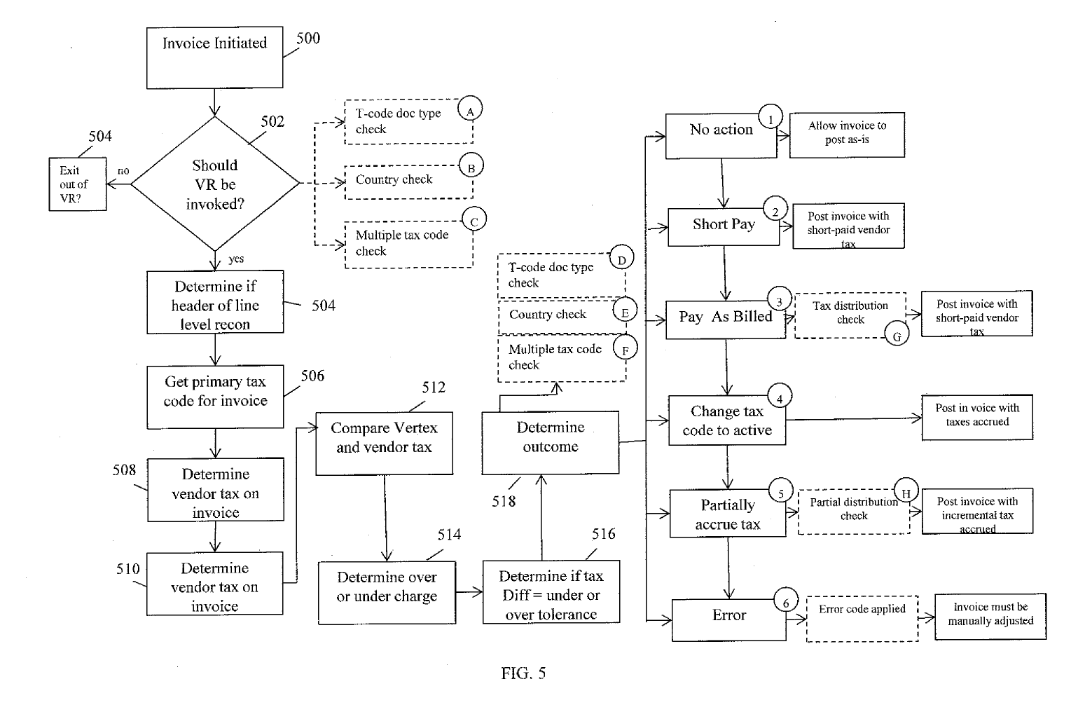

FIG. 5 is a flow diagram showing how VR 200 adjusts invoices, performed according to principles of the invention. At step 500, an invoice is initiated. At step 502 a check is made to determine if VR should be invoked. This may include checking the T-code document type, country code and/or multiple tax code. If it is determined that VR 200 should not be invoked, then the process may end at step 504. If however, VR 200 should be invoked, then at step 504, a determination is made if a header or line level reconciliation is appropriate. At 506, the primary tax code for the invoice is obtained. At step 508, determine the vendor tax on the invoice. At step 512, the third party tax (e.g., Vertex tax) is compared to the vendor tax. At step 514, an over or under charge is determined. At step 516, a determination of a tax difference is made. This may be accomplished by reading the configuration tables of VR 200. As a result, several outcomes may be possible as denoted by reference numerals 1-6. These include: no action, short pay (part of bill is paid), pay as billed, change tax code to active, partially accrue tax, or an error may be generated.

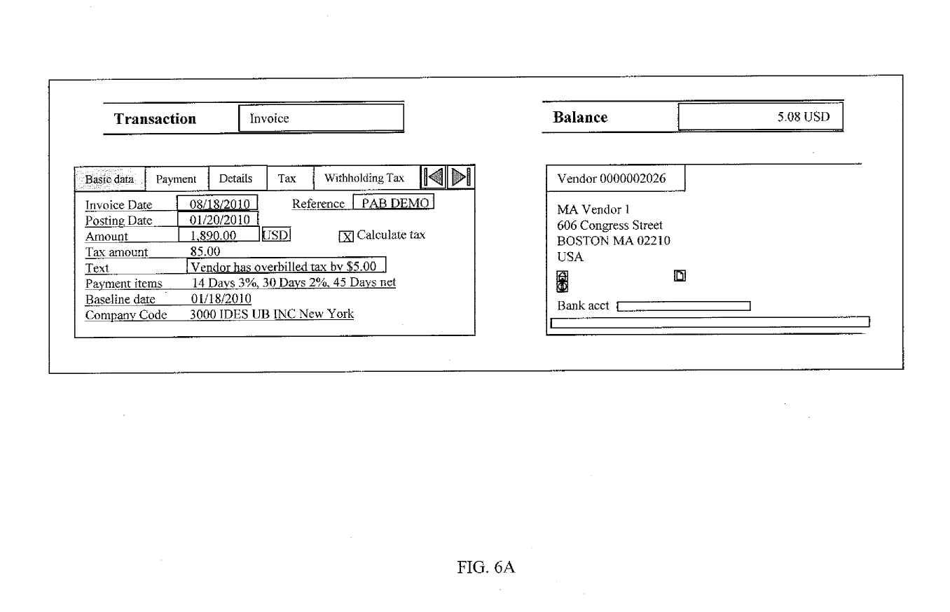

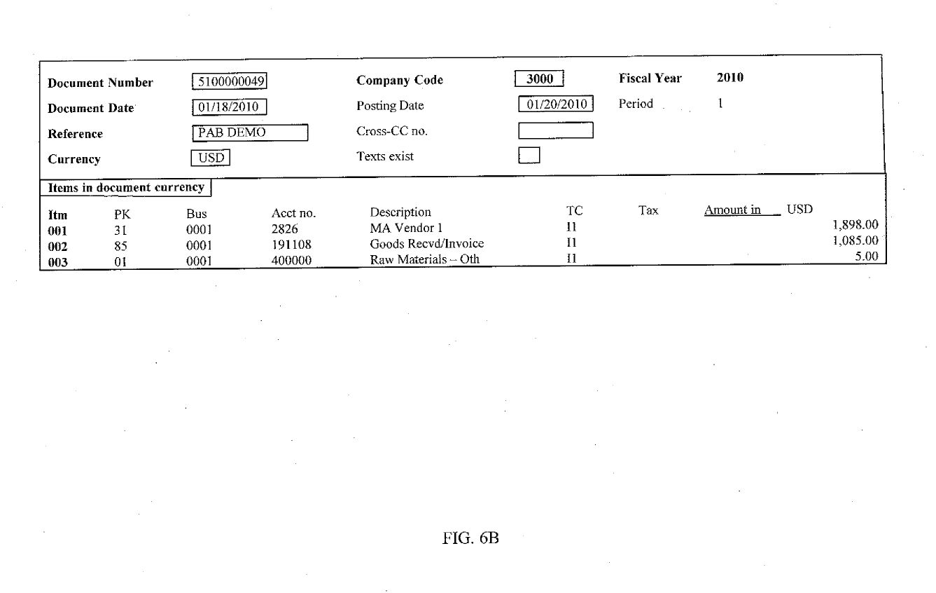

FIG. 6A is an illustration of a screenshot that a user may view during the processing of VR 200, configured according to principles of the invention. In this scenario, a vendor has billed Company 3000 a $90.00 tax shown in the invoice. According to tax software the tax should be $85 dollars. This is an overcharge of $5.00, but Company 3000 wishes to pay the vendor as billed ($90.00). In FIG. 6A, VR 200 has automatically adjusted the amount expensed to include the additional $5.00 tax charge by the vendor. Since this may be within an acceptable range, the vendor may be paid as billed.

FIG. 6B is an illustration of a screenshot that a user may view showing a result of the processing of VR 200 for the invoice of FIG. 6A, configured according to principles of the invention. VR 200 has automatically adjusted the amount expensed to include an additional $5.00 tax charged (as raw materials) by the vendor.

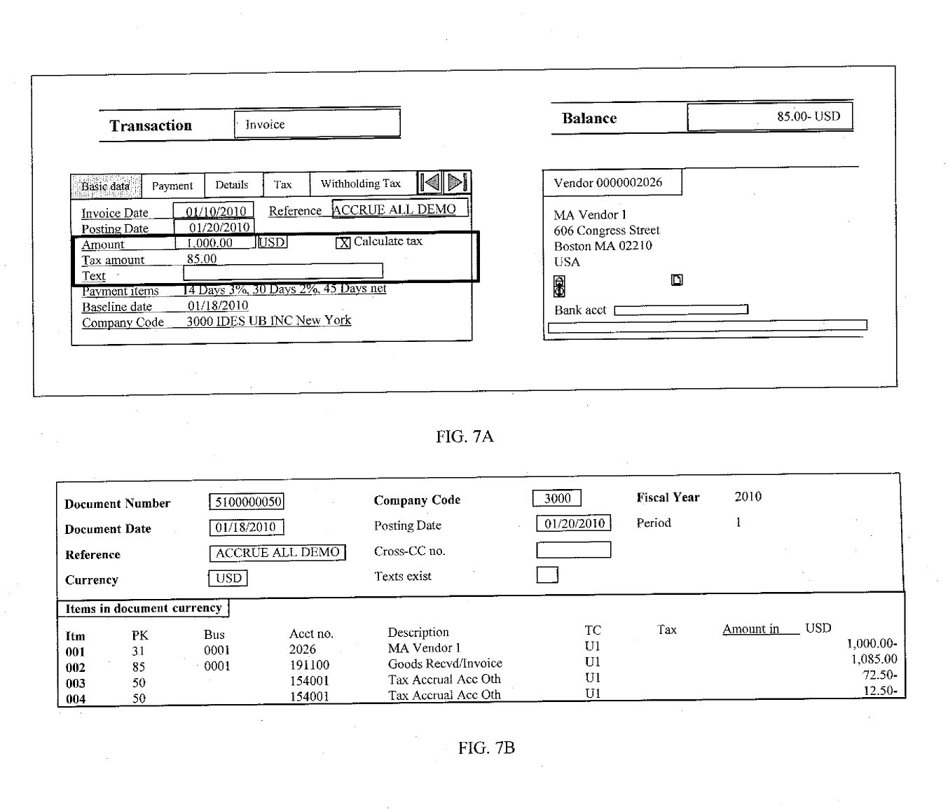

FIG. 7A is an illustration of a screenshot that a user may view during the processing of VR 200, configured according to principles of the invention. In this scenario, a vendor did not bill any tax. The vendor has under billed by $85.00 when compared to a third party tax (e.g., Vertex). VR 200 automatically flips the tax code to U1, i.e., to accrue. FIG. 7B is a screenshot showing the VR 20 result, configured according to principles of the invention. The full $85.00 is accrued.

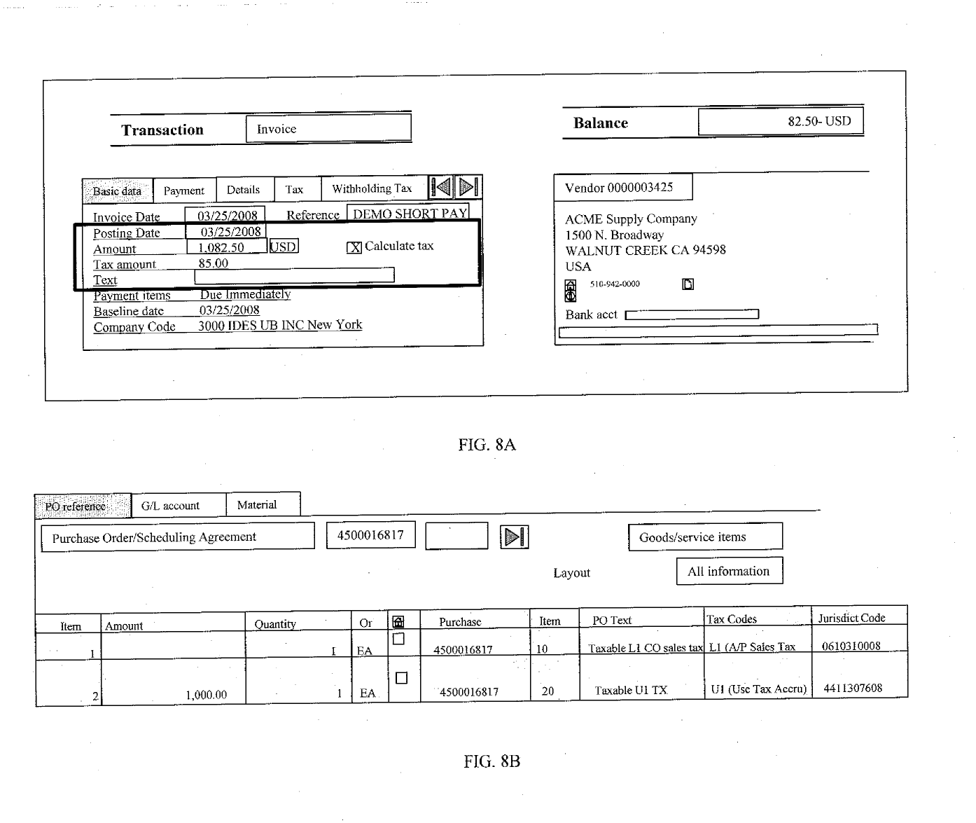

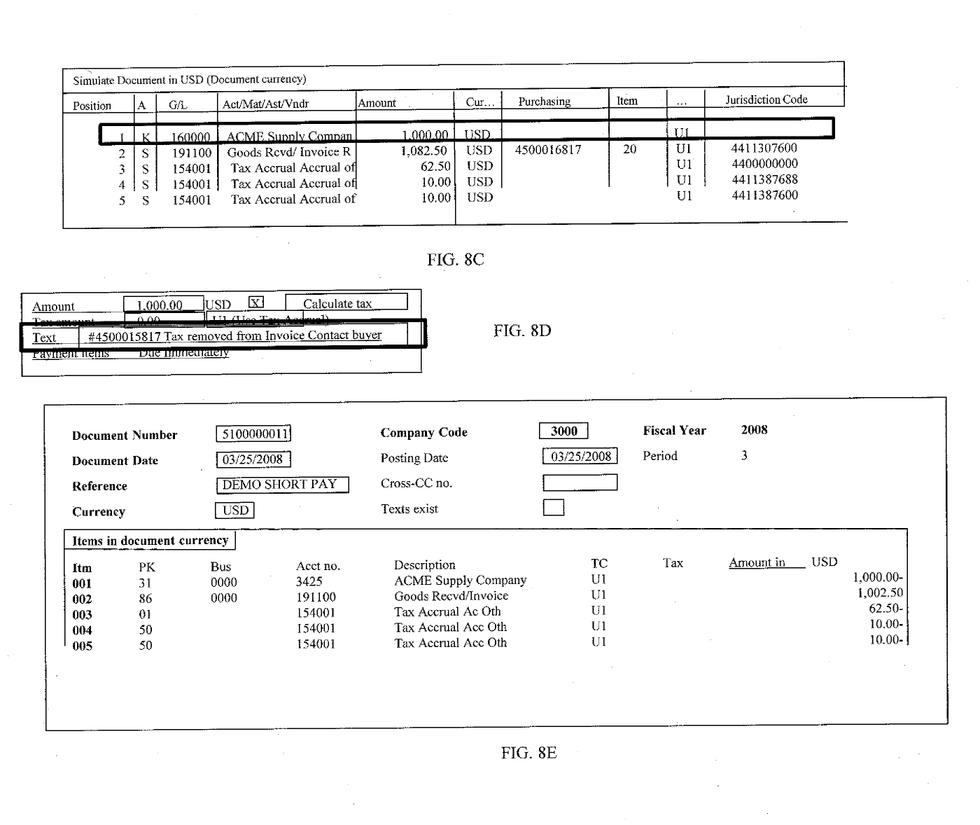

FIGS. 8A to 8E show screenshots of a scenario where a vendor overcharges a tax amount, configured according to principles of the invention. FIG. 8A shows that the vendor (ACME Supply Company) has over-billed Company 3000 by $82.50 on a direct pay invoice. FIGS. 8B and 8C show that VR 200 automatically adjusts the vendor payable amount to exclude the tax, leaving $1000.00. FIG. 8D shows that a message (highlighted) may be automatically generated to appear on a check remittance stub. FIG. 8E shows that the invoice has been short paid by the tax amount and that the tax is accrued.

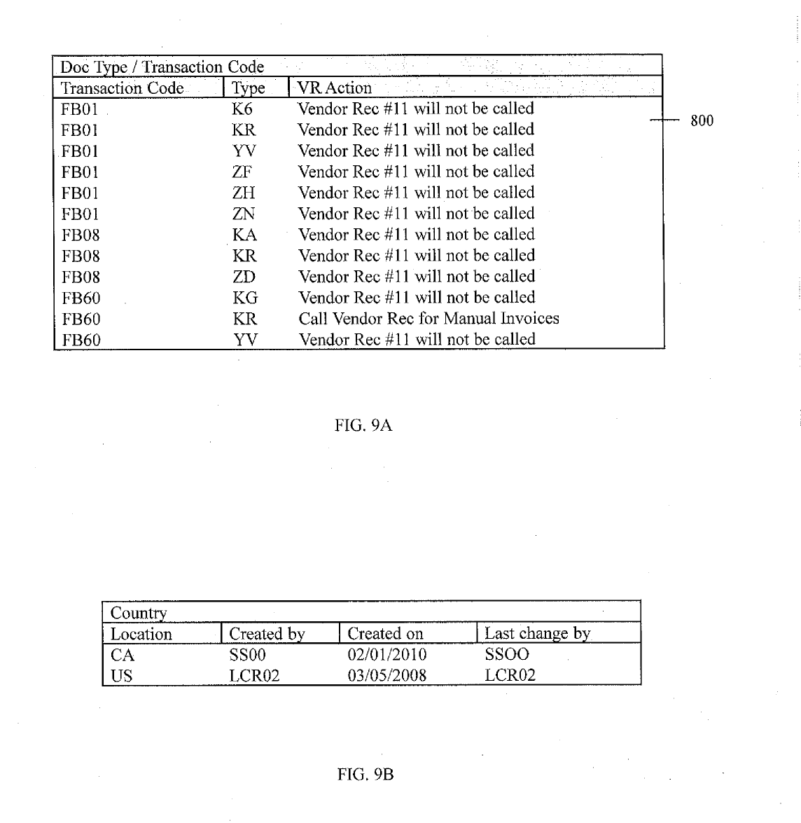

FIG. 9A shows an example of VR 200 configuration table, configured according to principles of the invention. The table 800 is organized by SAP® transaction code (column labeled Transaction Code) and document type (column labeled Type) with a column defining whether or not VENDORecon (VR 200) will be called. Possible VR actions may include: call VENDORecon for automated invoices (such as EDI, Idocs, etc), call VENDORecon for manual invoices (like MIRO or FB60 transaction codes) or VENDORecon is not to be called. FIG. 9B is a table that defines for what countries VENDORecon should be used, configured according to principles of the invention. In the example of FIG. 9B, VENDORecon is to be called only for invoices with a US or Canadian company code.

The following requirements should be considered and defined prior to configuring the VR tables:
Does VR need to be invoked for US invoices only, or are other country's invoices going to be involved?
   See “Country” Table in the previous section of this document
   Invocation of VR can be based on Tax Procedure or country of the SAP® company code
What transactions and document types should invoke or bypass VR?
   See “Doc Type/Transaction Code” table in the previous section of this document. Decisions should be made on the following types of invoices:
      Manual invoices (i.e., MIRO and FB60)
      Automated invoices (i.e., EDI, IDocs)
      Should VR reconcile the invoice at the header/invoice level or on the line level?
   The key driver behind this is whether vendor-billed tax is entered at a line level or the header level.
Define the tax difference tolerances
   VR allows tolerances to be defined on the Tax Difference Amount or Percentage to prevent VR from automatically reconciling large dollar tax differences.
   Tax Difference Amounts—Dollar difference between the tax software tax and the tax charged by the Vendor
      Vendor tax $6.00
      Tax software tax $8.00
      Tax Difference Amount $−2.00
   Tax Difference Percentage—Tax difference may be defined as the relative percentage of the Vertex tax
      Vendor tax $10.00
      Tax software tax $8.00
      Tax Difference % 25%
   Tax Difference Percentage—Tax difference may be defined as the absolute percentage of the Vertex tax
      Tax Base $100.00
      Vendor tax $10.00
      Tax software tax $8.00
      Tax Difference % 2%
Define the outcomes of the VR module 200, based on the possible scenarios and variables such as invoice amount, tax code, vendor, state, tax software taxability, tax difference tolerances and under/overcharge. The VR 200 logic may result in the following outcomes:
   No adjustment needed—the invoice is in balance and can be posted as-is.
   Pay the vendor as billed (PB) and allocate/post the adjustment to the expense account. A prerequisite for this outcome is the creation of an additional custom Tax Condition (in the Tax Procedure) to handle the tax adjustment. A control total can be defined so that taxes paid as billed do not exceed a reasonable amount (e.g., 10% or 20%).
      For multiple line invoices that are processed at Invoice level VR, any tax adjustment posted to the Custom Tax Condition (as a result of the Pay-as-Billed or PB outcome) needs to be allocated among the lines for expense purposes. The pro-ration rules are defined in the “PB Distribution” table.
   Accrue the entire tax amount with a specific tax code because the vendor did not bill any tax.
   Accrue part of the tax amount that the vendor did not charge. The distribution of this partial accrual can be pro-rated among the state, county, city and district levels and this can be defined in the “Partial Accrual Distribution.”
   Error because VR cannot reconcile the outcome.
Define the Return Messages on Manual Invoices

In another aspect of the invention, a system and method for calculating and recording tax accruals on inventory movements, tax only debits and credits for both AP and AR, allocation of tax, and the like, is provided and generally includes module 300, referred to as flexRFC. In particular, the flexRFC 300 enables SAP® systems and tax software users to create tax adjustments in SAP® records while maintaining the integrity of the tax calculation and reporting data from/in the tax software. In one aspect, flexRFC 300 may enable the tax software to use tax accruals on inventory movements processed in the SAP® Material Movements program. FlexRFC 300 functionality may include one or more of the following:
Generates the Remote Function Call (RFC) to a tax software to calculate the use tax;
Creates the necessary FI documents to post any tax accruals to the GL;
Posts the use tax accrual to the Tax Software Tax Journal or Register File to facilitate returns preparation;
Allows users to restrict the type of transactions that will run through the flexRFC accrual process—by variables such as movement type, cost center, general ledger (GL) account and plant;
Allows users to view and select the line items that are to be processed by flexRFC prior to creating financial documents;
Can be executed on a scheduled or on-demand basis and in test mode prior to FI posting;
Facilitates large volumes of accruals with background program option; and/or
Compatible with Tax Software such as, e.g., Vertex® Q-Series and O-Series, OneSource, Taxware, and Sales Tax Office.

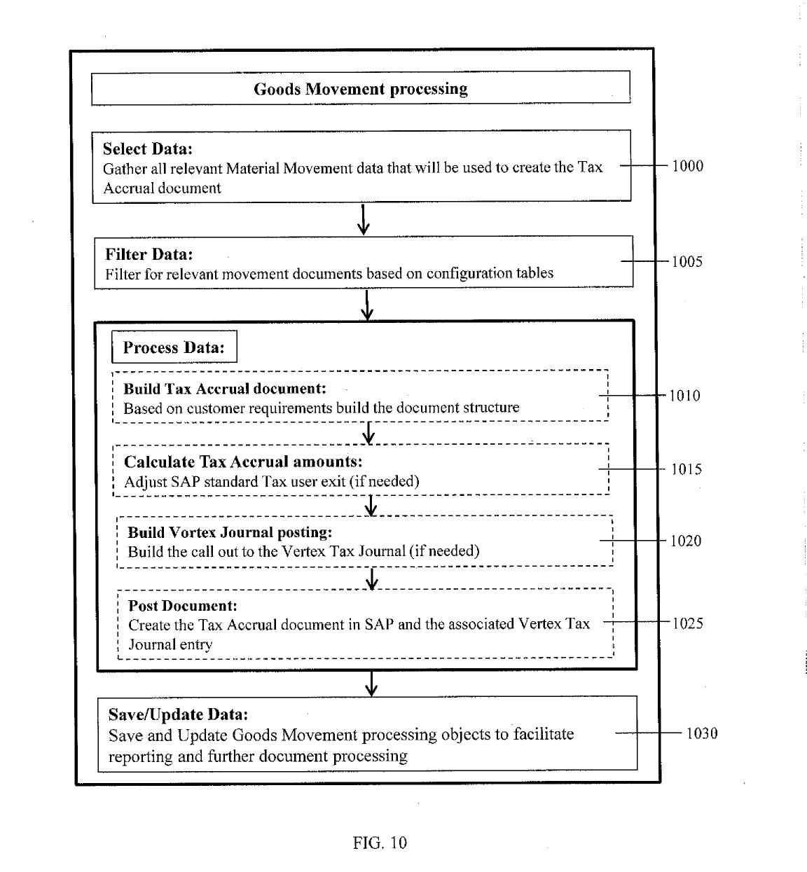

FIG. 10 is a flow diagram showing the processing of flexRFC 300, performed according to principles of the invention. At step 1000, all relevant material movement data that will be used to create a tax accrual document may be gathered. At step 1005, relevant movement documents may be filtered base on configuration tables. At step 1010, a tax accrual document may be built based on a customer's requirements. At step 1015, tax accrual amounts may be calculated. SAP® standard tax user exit may be adjusted as necessary. At step 1020, a Vertex Journal posting may be built, if needed. At step 1025, a tax accrual document may be built in SAP® and the associated Vertex, or other third party tax software, tax entry. At step 1030, goods movement objects may be updated and saved to facilitate reporting and further document processing.

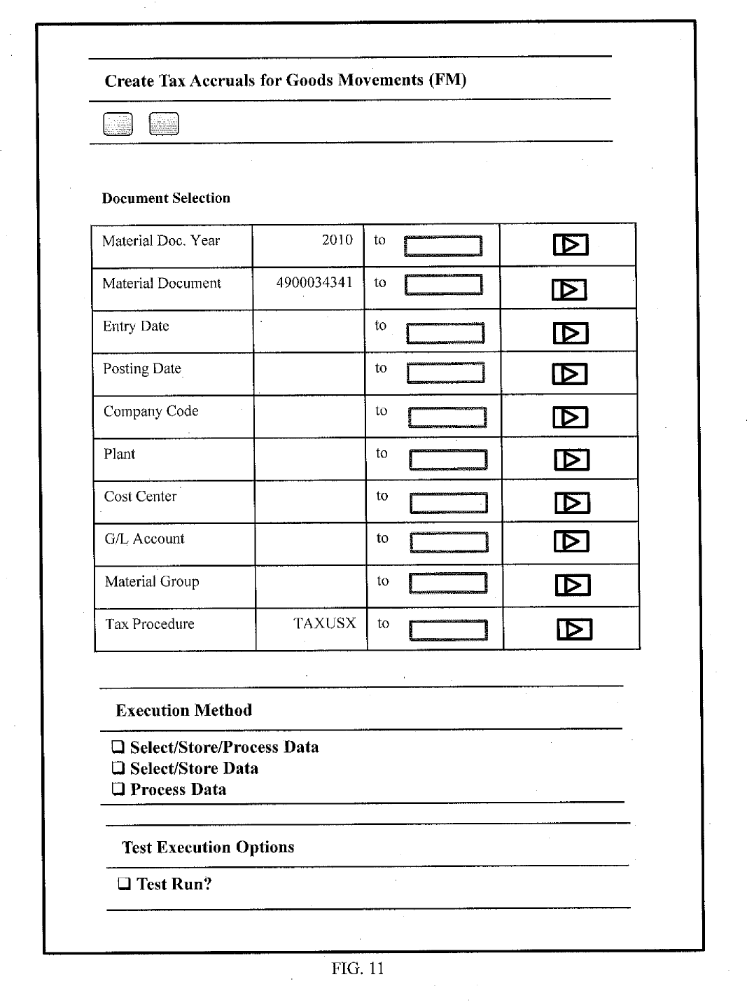

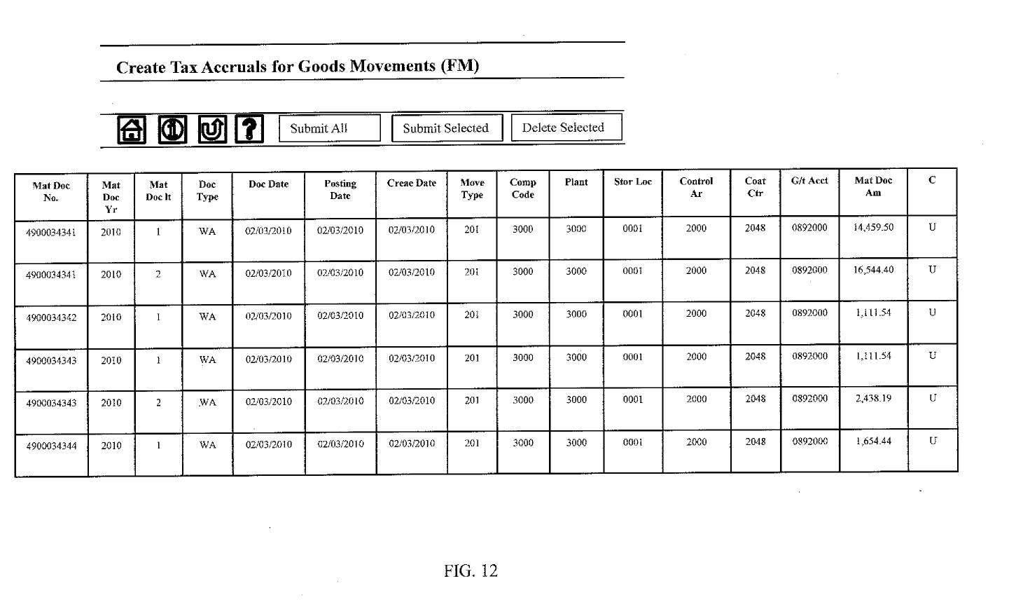

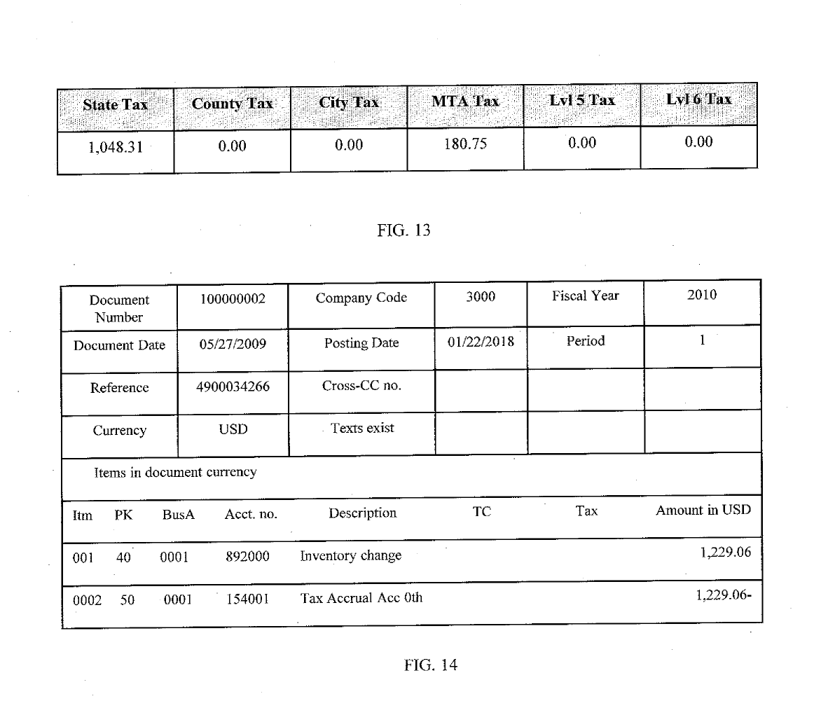

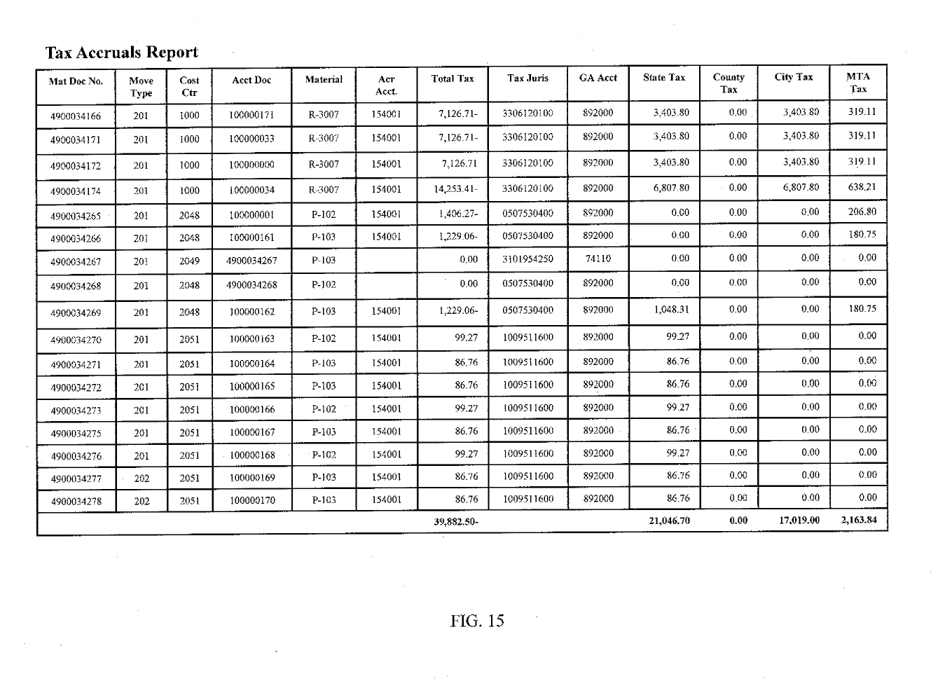

FIG. 11 is a screenshot of a Create Tax Accruals, configured according to principles of the invention. Once parameters (such as Company code and posting dates) for desired accruals have been defined, the program may be executed in FM (function module) which posts tax accruals only, or BDC (Batch Data Communications) modes. Upon execution, the Goods Movement program of flexRFC 300 may perform the following:
Gathers financial documents subject to tax accrual based on the input parameters and configuration tables:
   Movement type
   Company code
   Plant/storage location
   Cost objects—assets, cost centers, internal orders, WBS elements
   GL accounts
FIG. 12 presents a list of financial documents for the user to:
   Submit all,
   Submit selected, or
   Delete selected, for Tax accrual function
The flexRFC program may process each submitted material movement document by initiating a remote function call to Vertex (or other similar program) and sending the data to Vertex to determine the use tax. The standard data passed from SAP® to Vertex may include, but is not limited to:
   SAP® Company code=Vertex Taxpayer ID
   Material Movement posting date=Vertex Invoice (tax) date
   Tax accrual posting date=Vertex posting (reporting) date
   SAP® material document amount=Vertex gross amount
   Cost center tax jurisdiction code=Vertex ship-to location
Vertex determines the use tax and returns the amount to the flexRFC program
After the tax is returned to the flexRFC program,
   If flexRFC is run in Test mode: no FI document is created, but the tax calculated can be seen directly on the screen as shown in FIG. 13.
   If flexRFC is run in full mode, the FI document is posted with the tax accrual expense and references to the original Financial Document as shown in the screen shot of FIG. 14.
The flexRFC program stores the Accruals on the tax accrual report as shown in FIG. 15.

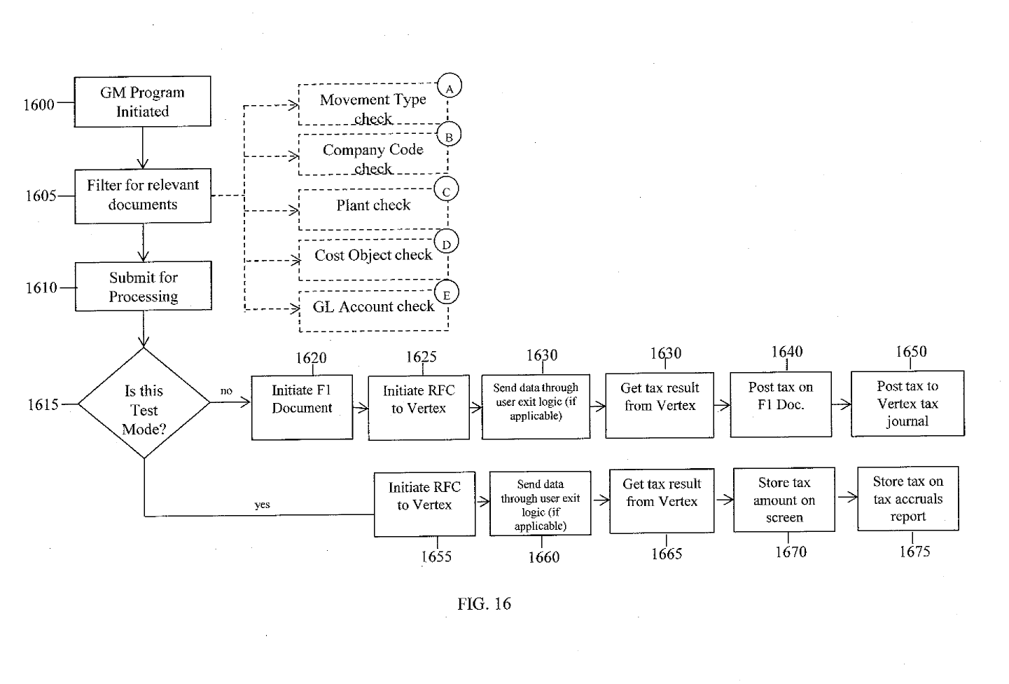

FIG. 16 is a flow diagram showing the decision points and outcome options for flexRFC processing, performed according to principles of the invention. At step 1600 flexRFC processing may be initiated. At step 1605, documents are filtered for relevance. At step 1610, documents are submitted for processing. At step 1615, a check is made as to whether or not this is a test mode. If not, then at step 1620 FI document is initiated. At step 1625, a remoter function call (RFC) may be made to Vertex. At step 1630, data may be sent through user exit logic (if applicable). At step 1640, a tax result may be obtained from Vertex. At step 1645, the tax may be posted on a FI document. At step 1650 the tax may be posted to the Vertex journal.

If at step 1615 the result is a test mode, then at step 1655, a RFC is made to Vertex. At step 1660, relevant data may be sent through user exit logic, if applicable. At step 1665, a tax result is obtained from Vertex. At step 1670, the tax may be stored on screen. At step 1675 the tax may be stored on the tax accrual report.

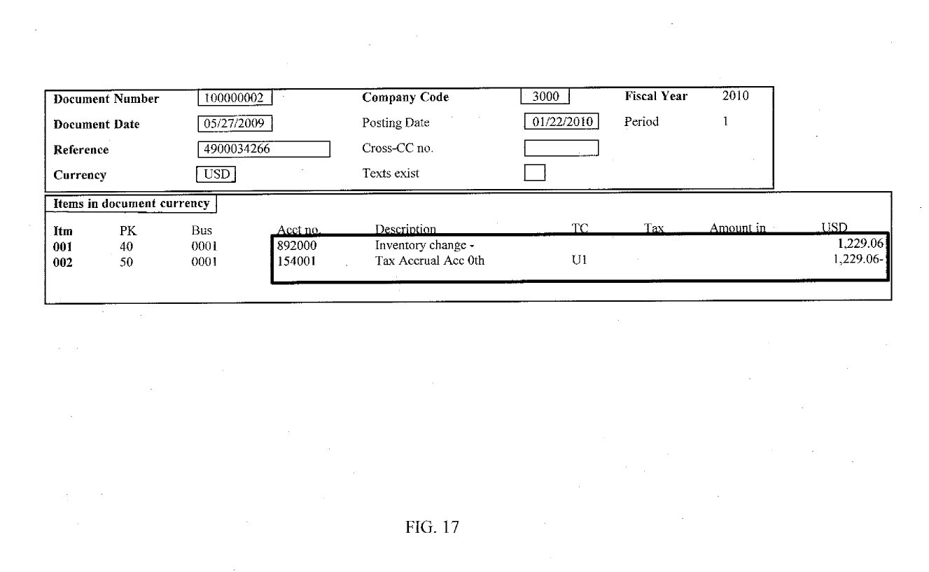

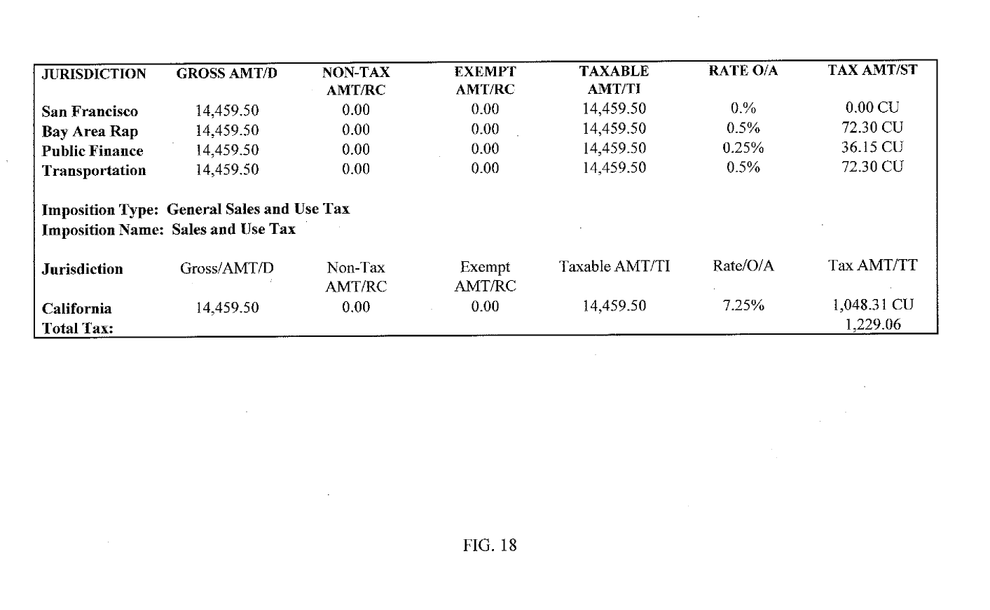

As a result of the exemplary process of FIG. 16, FIG. 17 shows an FI accounting document automatically created by the flexRFC to expense tax accrual and FIG. 18 shows an exemplary screenshot of the use tax accrual in Vertex reporting that may be exported to Vertex returns. flexRFC posts the tax accrual to the Vertex journal/register file. The posting reflects tax due for California being $1,048.31.

In a further aspect of the invention, a system and method for evaluating the accuracy of transaction tax results is provided and includes module 400 generally referred to as TaxRay. In particular, the SPOT/TaxRay Diagnostic (or “TaxRay”) comprises a suite of custom ABAP code that automates the process of evaluating the accuracy of transaction tax results on procure-to-pay (P2P) transaction data. TaxRay 400 may offer one or more of the following functionalities:
Screens that look and feel like standard SAP® programs—TaxRay 400 runs within the SAP® application environment and can be executed on a scheduled or on-demand basis;
Table configuration to define documents that should be analyzed by TaxRay 400;
Analysis can be configured based on variables such as one or more of (or all): tax codes, vendors, GL accounts, material groups, cost objects and expected taxability by state;
Analysis and evaluations can be defined by matching key-word variables and multi-point verifications; and/or
Capable of handling evaluations on PO and Invoice data.

TaxRay 400 may be installed and integrated with ERP system 100. TaxRay 400 analyzes gaps in reporting data such as internal audit reports and identifies gaps (e.g., incorrect amounts) in the calculated tax amounts. A user may run the TaxRay 400 functions at will and may receive outputs of indications of gaps in tax amounts for transactions. A user may search for a specific issue related to an identified issue and manually intervene to resolve the discrepancy.

For example, transactions involving Office Supplies are usually taxable transactions in most states. Running TaxRray 400 may identify a gap in the taxable amount for a transaction. Alternatively, a user of TaxRay 400 may search for TaxRay 400 reports involving Office Supplies. A user may then identify a solution to a discrepancy and construct a rule for Office Supplies that may be automatically applied to future transactions involving Office Supplies as being taxable, and may apply a particular rate, for example. Thereafter, every transaction involving Office Supplies may be checked to verify accuracy in system transactions. The corrections/revisions may be stored in the ERP 100 database 115.

TaxRay 400 may be configured to conduct validation checks during a diagnostic run including one or more of:
Validates that the invoice should invoke the TaxRay process based on a number of variables such as Transaction Code, Document Type, Country and Tax Procedure.
Validates Tax Codes. Compares the Tax Code on the transaction line to the Rules Uploaded to confirm the correct Tax Code is on the transaction. This feature will allow you to confirm Direct Pay, non-Direct Pay and exempt Tax Code defaults. The program also identifies the tax relevant transactions missing tax codes.
Conducts WordLink validations of Exempt Tax Codes. For Exempted Tax Codes (that did not call the external tax system), the TaxRay program may run through a series of checks to validate that the transaction is most likely exempt. It is possible to validate the Exempt Tax Code based on WordLink checks in the Vendor, GL account, Cost Objects and Line Item Descriptions.
Conducts WordLink validations of data selections. For GL accounts and/or Material Groups entered, TaxRay may compare with Good and Bad WordLink associations to flag Good and Bad data selections. These can be used for training and internal audit purposes.
Conducts WordLink validations of Tax Outcomes. For transaction lines, TaxRay may compare the ultimate tax outcome (Taxable or Exempt) with wordlink combinations to determine if possible incorrect results appear. For example, if TaxRay sees tax paid on “Legal Fees”, it will flag it as possible overpaid.
Conducts System Compare of Tax Outcomes. For transaction lines, TaxRay may compare the ultimate tax outcome (Taxable or Exempt) with rules uploaded to validate if the outcome is consistent with the rules.
Rate Check. For transaction lines, TaxRay may compare the actual tax rate paid or accrued with the standard rate in the Tax System and flag differences. This feature can identify transactions where vendors were paid as billed or a non-standard rate was applied.
Calculate Tax Check—This validation provides dollar and line item statistics by AP user on checking or un-checking the Calculate Tax and Calculate Taxes on Net settings.
TJC Check—WordLink validations maybe used to validate that specific Tax Jurisdiction Codes (TJCs) are acceptable when tied to certain plants, cost objects, vendors, line item descriptions. For example, if a transaction has a TX TJC, but the plant is in CA, this might raise a review flag.
Statistics—all outcomes, tax calculations, flagged items, data selections, user processing can be compiled for statistical reporting. This feature can provide significant benefit for internal audit, training and management purposes.
Linkage to Scanned Images—for transactions flagged for review, the user can execute a utility that may retrieve the scanned images linked to the invoice (if available) and store it for easy access when reviewing the flagged lines. In addition, the user can record data from the invoice in TaxRay (such as ship-to, actual item purchased) so TaxRay can run through a second round of analysis to determine the correct outcome based on the data extracted from the scanned image.

While the disclosure makes reference to specific systems that may be used to implement the disclosed methods, any appropriate system or systems may be used, as will be understood by one skilled in the art, without departing from the spirit and scope of the disclosure.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications, or modifications of the invention.

What is claimed:

1. A system for reconciling a tax amount calculated by different sources, the system comprising:
an enterprise resource platform (ERP) having a processor operable to execute ERP software and configured to generate one or more remote function calls to tax software;
the tax software independently installable and operable to execute on the ERP platform and configured to execute the one or more function calls including configured to execute logic to determine accuracy of a tax item related to an invoice or a purchase order; and
an output device to receive an output from the tax software indicative of the accuracy of the tax item.

2. The system of claim 1, wherein the tax software is configurable to determine an output based on variables such as tax codes, invoice thresholds, vendors, states, overpayment vs. underpayment and taxability.

3. The system of claim 1, wherein the tax software is configurable to determine whether one of:
a purchase order based invoice and a non-purchase order based invoice has an inaccurate tax amount and provides an output indicative of a correct tax amount or indicative of no change.

4. The system of claim 3, wherein the tax software is configurable to operate at a line or invoice level, and configurable to process manually input invoices and automatic invoices.

5. The system of claim 4, wherein the tax software reconciles the invoice by indicating at least one of:
pay a vendor as billed;
accrue tax if not billed by the vendor;
accrue partial tax not billed by the vendor; and
short-pay the vendor.

6. The system of claim 1, wherein a configuration table setting in a memory determines whether or not the tax software is to be called using the one or more remote function calls.

7. The system of claim 6, wherein the configuration table setting determines whether or not the tax software is to be called based on one of: a type of document, tax code, company code and a country.

8. The system of claim 1, wherein the tax software is configured to calculate and record tax accruals on financial transactions.

9. The system of claim 8, wherein the tax software is configured to create a FI document and post a tax accrual to a general ledger.

10. The system of claim 8, wherein variables restrict the type of material movement transactions from being processed by the tax software.

11. The system of claim 8, wherein the tax software is configurable to execute on a schedule or on a demand basis, and is configured to run in test mode prior to FI posting.

12. The system of claim 8, wherein the tax software calculates use tax.

13. The system of claim 1, wherein the tax software analyzes gaps in reporting data between tax software and ERP software and provides data for internal audits or external audits and identifies gaps in reported tax amounts.

14. The system of claim 13, wherein the tax software reports gaps in tax amounts for transactions.

15. The system of claim 13, wherein a table configuration defines documents for analysis by the tax software, the analysis being controlled by variables including at least one of: a tax code, a vendor, a General Ledger account, a material group, a cost object, and an expected taxability by state.

16. A computer program product embodied on a computer readable medium and comprising executable code for reconciling of a tax amount that when read and executed by a computer causes the execution of the following steps:
processing at a tax software module a remote function call called from an ERP platform to execute logic to determine accuracy of a tax item related to an invoice or a purchase order; and
outputting an indication of the accuracy of the tax item.

17. The computer program product of claim 16, wherein the tax software module determines an output based on a variable including a variable indicating at least one of a tax code, an invoice threshold, a vendor, a state, an overpayment vs. underpayment and taxability.

18. The computer program product of claim 16, wherein the tax software module determines whether one of: an invoice purchase order based invoice and a non-purchase order based invoice has an inaccurate tax amount and provides an output indicative of a correct tax amount or indicative of no change.

19. The computer program product of claim 16, wherein the tax software module operates at a line or invoice level and processes manually input invoices and automatic invoices.

20. The computer program product of claim 16, wherein the tax software module analyzes gaps in reporting data for internal audits or external audits and identifies gaps in reported tax amounts and reports gaps in tax amounts for transactions.

21. The computer program product of claim 20, wherein a table configuration defines documents for analysis by the tax software module, the analysis being controlled by a variable including a variable indicating at least one of: a tax code, a vendor, a General Ledger account, a material group, a cost object, and an expected taxability by state.

22. A computer-implemented method for reconciling of a tax amount, the method comprising:
processing tax software by a computer processor including a remote function call called from an enterprise resources planning (ERP) platform to execute logic to determine accuracy of a tax item related to an invoice or a purchase order; and
outputting to a device an indication of the accuracy of the tax item.

23. A computer-implemented method of claim 29 further comprising determining the indication based on a variable indicating at least one of: a tax code, invoice thresholds, a vendor, a state, an overpayment vs. underpayment and taxability.

24. The computer-implemented method of claim 29, further comprising the step of determining whether one of: a purchase order based invoice or a non-purchase order based invoice has an inaccurate tax amount and providing an output indicative of a correct tax amount or indicative of no-change.

25. The computer-implemented method system of claim 29, wherein the tax software operates at a line or invoice level, and processes manually input invoices and automatic invoices.

26. The A computer-implemented method of claim 29, further comprising reconciling the invoice by indicating at least one of:
pay a vendor as billed;
accrue tax if not billed by the vendor;
accrue partial tax not billed by the vendor; and
short-pay the vendor.

27. The A computer-implemented method of claim 29, further comprising the step of analyzing for gaps in reporting data for internal or external audits of the invoices and identifies gaps in reported tax amounts.

28. The computer-implemented method of claim 29, further comprising the step of calculating and recording tax accruals on inventory movements by the tax software.

29. The computer-implemented method of claim 29, further comprising the step of integrating the tax software in to the ERP platform so that the ERP platform accesses the tax software through remote function calls.

30. The system of claim 8, wherein the financial transactions includes an inventory movement.
